(19) United States
(12) Patent Application Publication
(10) Pub. No.: US 2010/0088090 A1
(43) Pub. Date: Apr. 8, 2010

(54) ARITHMETIC ENCODING FOR CELP SPEECH ENCODERS

(75) Inventor: Tenkasi V. Ramabadran, Naperville, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/247,440

(22) Filed: Oct. 8, 2008

(51) Int. Cl. G10L 19/00

(52) U.S. Cl. 704/219; 704/223; 704/E19.035

(57) ABSTRACT

A communication system (100) includes devices (102, 104, 200) for transmitting and receiving digital audio. The devices use audio encoders (210, 804) and decoders (222, 916) such as ACELP or DCT/IDCT to compress and decompress audio and use arithmetic encoders (212) and decoders (220) to encode and decode the compressed audio on-the-fly (without a codebook of pre-stored codes).

### FIELD OF THE INVENTION

The present invention relates generally to signal encoding and in particular to speech encoding.

### BACKGROUND

For most of the period since the advent of wireless communication, information (e.g., audio, video) has been communicated through a process that involved continuously modulating a carrier signal with an information bearing signal, for example, an audio or video signal.

In the 1990's progress in digital circuitry in terms of processing power and integrated circuit cost reduction allowed digital technology to supplant analog technology in cellular telephony. Digital technology is less prone to various types of analog signal degradation such as fading. Moreover, digital technology facilitates use of advanced techniques such as error-correction to achieve improved quality and data compression which results in lower bandwidth requirements for the same quality.

For cellular telephony in particular the primary form of data to be communicated is speech audio. Typically, superior compression can be achieved by using a compression algorithm that is specifically designed for the type of data to be compressed. A compression technique that is especially suited to speech audio is known as Code-Excited Linear Prediction (CELP). CELP is based on a model of the human vocal apparatus, viz., the vocal cords and the vocal tract. In the model, the vocal tract is modeled by a discrete time signal filter that has a frequency response that mimics the resonances of the vocal tract, and sounds which in reality are generated by bursts of air passing the vocal cords and exciting acoustic resonances in the vocal tract are simulated (e.g., in a cell phone) by the output of the filter when a series of pulses are input into the filter. A discrete portion of speech (e.g., a frame or sub-frame) is then represented by a set of pulses and optionally by filter coefficients defining the filter. The set of pulses is described by the number of pulses, the magnitudes of the pulses, the positions of the pulses within the frame (or sub-frame), and the signs (±) of the pulses. As a person is speaking into his or her communication device, for each successive sub-frame the foregoing information must be transmitted; however, typically the information itself is not transmitted, rather the information is encoded and a code representing the information is transmitted. One way of doing this is to store each and every possible combination of the number, magnitudes, positions, and signs of the pulses in a codebook, with each possible combination having a unique address in the codebook, and to transmit the address in some form rather than transmitting the information about the pulses. A drawback of this approach is that if it is desired to achieve higher audio fidelity by allowing for more pulses or more precision in describing the positions or magnitudes of the pulses, the size of the codebook will increase thereby increasing the memory and search requirements for the codebook.

### SUMMARY OF THE INVENTION

According to one aspect, the invention provides a transmitting voice communication device that has an audio encoder that encodes audio coupled to an arithmetic encoder which further encodes the output of the audio encoder. According to certain embodiments the audio encoder is a CELP audio encoder. According other embodiments the audio encoder is a Discrete Cosine Transform (DCT) encoder.

According to another aspect, the invention provides a receiving voice communication devices that has an arithmetic decoder that decodes received information encoding audio and passes output to an audio decoder which further decodes the output of the arithmetic decoder. According to certain embodiments the audio decoder is a CELP decoder and according to other embodiments the audio decoder is a DCT decoder.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of a communication system according to an embodiment of the invention;

FIG. 2 is a block diagram of a communication device according to an embodiment of the invention;

FIG. 3 is a high level flowchart of a method of processing audio to be transmitted according to an embodiment of the invention;

FIG. 4 is a high level flowchart of a method of processing received digital audio signals according to an embodiment of the invention;

FIG. 5 is a diagram illustrating the principle of arithmetic encoding for a binary sequence;

FIG. 6 is a flowchart of an arithmetic encoder according to an embodiment of the invention;

FIG. 7 is a flowchart of an arithmetic decoder according to an embodiment of the invention;

FIG. 8 is a high level flowchart of a method of processing audio to be transmitted according to an alternative embodiment of the invention;

FIG. 9 is a high level flowchart of a method of processing received digital audio signals according to an alternative embodiment of the invention;

FIG. 10 is a front view of a wireless communication device according to an embodiment of the invention;

FIG. 11 is a block diagram of the wireless communication device shown in FIG. 10 according to an embodiment of the invention; and

FIG. 12 shows how values used in arithmetic encoding are represented in binary fractions according to embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to digital speech communication. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

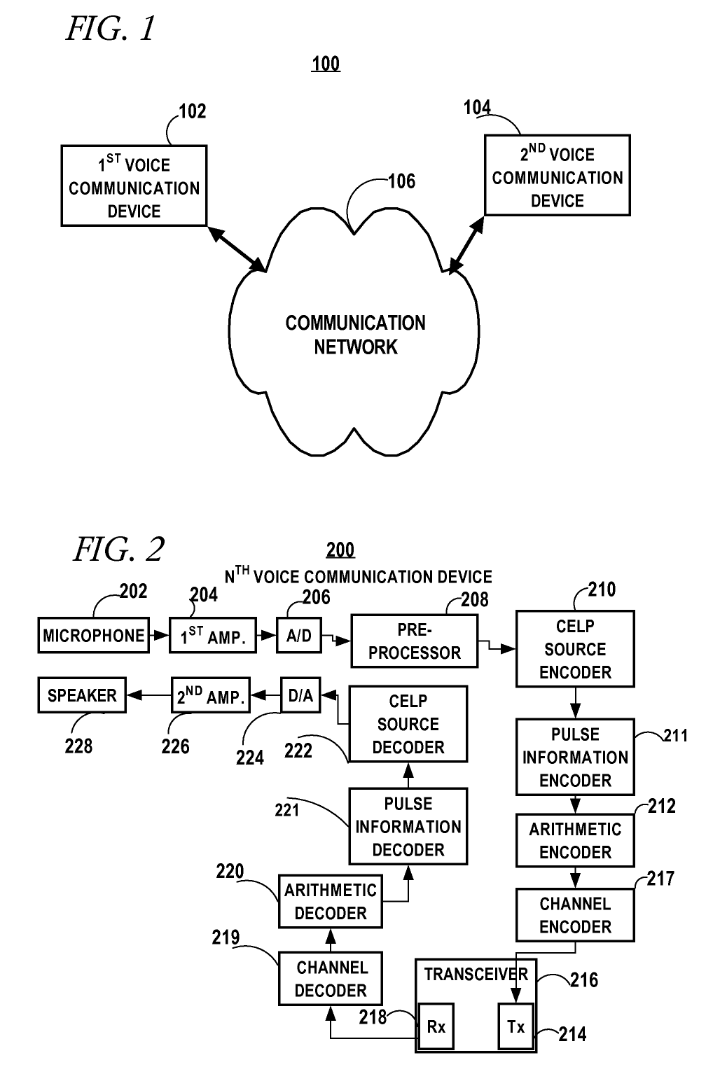

FIG. 1 is a block diagram of a communication system 100 according to an embodiment of the invention. The communication system 100 comprises a first voice communication device 102 and a second voice communication device 104 communicatively coupled through a communication network 106. Both devices 102, 104 can have both transmit and receive capability or alternatively one of the devices 102, 104 can have only transmit capability and the other device only receive capability. The communication network 106 may, for example, include wireless radio channels and or fiber optic channels. The communication network 106 can for example comprise a cellular telephone network, a landline telephone network, a satellite telephone network, the Internet, a broadcast network such as a digital television network, or a digital radio network.

FIG. 2 is a block diagram of an N^{TH} communication device 200 according to an embodiment of the invention. Either or both of the devices 102, 104 shown in FIG. 1 can have the internal architecture shown in FIG. 2. Referring to FIG. 2 the device 200 comprises a microphone 202 coupled through a first amplifier 204 to an analog-to-digital converter (A/D) 206. The A/D 206 is coupled to an audio preprocessor 208. The audio preprocessor 208 can, for example, perform noise filtering and echo cancellation. The audio preprocessor is coupled to a CELP encoder 210 such as an Algebraic CELP (ACELP) encoder. The ACELP is a form of Code-Excited Linear Predictive (CELP) encoder that uses a specially structured excitation codebook. Each code vector from such a codebook consists of a specified number of integer-valued pulses at specific positions within a frame (or sub-frame). The CELP encoder 210 determines a small set of vocal apparatus model parameters, including the pulse information (i.e., excitation code vector) described above which describes a driving function for the model vocal apparatus. The pulse information including (1) the number of pulses per frame (or sub-frame), (2) the magnitudes of the pulses, (3) the locations of the pulses, and (4) the signs (±) of the pulses that are produced by the CELP encoder 210 is used to represent speech audio.

If n is the number of pulse positions in a sub-frame and m is an upper bound on the sum of the integer pulse magnitudes for the sub-frame, then the number of pulses in the sub-frame denoted by k is bounded as follows:

1≦k≦min(m,n)

The number of possible sets of pulse positions in the sub-frame is given by:

$$( \begin{matrix}n \\ k\end{matrix} ) = \frac{n !}{k ! ( n - k ) !} = \frac{n \cdot ( n - 1 ) \cdot … \cdot ( n - k + 1 )}{k \cdot ( n - 1 ) \cdot … \cdot 1}$$

The number of possible ways to distribute the energy in the pulses is given by:

$$( \begin{matrix}m - 1 \\ k - 1\end{matrix} ) = \frac{( m - 1 ) !}{( k - 1 ) ! ( m - k ) !} = \frac{( m - 1 ) \cdot ( m - 2 ) \cdot … \cdot ( m - k + 1 )}{( k - 1 ) \cdot ( k - 2 ) \cdot … \cdot 1}$$

and the number of combinations of different signs of the pulses is given by 2^{k}.

Accordingly, the number of different unique sets of pulses for a sub-frame is given by:

$$N = {\sum }_{k = 1}^{min ( m , n )} ( \begin{matrix}n \\ k\end{matrix} ) ( \begin{matrix}m - 1 \\ k - 1\end{matrix} ) {2}^{k}$$

The preceding expression also gives the number of unique codes that would need to be stored if the prior art code-book approach were used.

Referring again to FIG. 2 it is seen that the CELP encoder 210 is coupled to a pulse information encoder 211. The pulse information encoder 211 serves to format the information produced by the CELP encoder 210 in a format acceptable to an arithmetic encoder 212. In preparation for arithmetic encoding, the positions of pulses can be represented by a binary vector that includes a one for each position where there is a pulse. This may be the native format used by the CELP encoder in which case no reformatting is necessary.

The magnitudes of the pulses can be represented by a magnitude vector in which each element is an integer representing the magnitude of a pulse. Such magnitude vectors can be converted to binary vectors (i.e., vectors in which each element is a single bit, viz., 0 or 1) by the pulse information encoder 211 by replacing each magnitude integer by a sequence of zeros numbering one less than the magnitude integer followed by a one. In as much as the last bit in the binary vector would always be a one, it can be ignored. The following are examples (for m=6 and k=3) of magnitude vectors at the left and corresponding binary vectors at the right that result from the foregoing conversion process:

$$( \begin{matrix}\begin{matrix}4 & 1 & 1\end{matrix} \\ \begin{matrix}1 & 4 & 1\end{matrix} \\ \begin{matrix}1 & 1 & 4\end{matrix} \\ \begin{matrix}3 & 2 & 1\end{matrix} \\ \begin{matrix}3 & 1 & 2\end{matrix} \\ \begin{matrix}1 & 3 & 2\end{matrix} \\ \begin{matrix}2 & 3 & 1\end{matrix} \\ \begin{matrix}1 & 2 & 3\end{matrix} \\ \begin{matrix}2 & 1 & 3\end{matrix} \\ \begin{matrix}2 & 2 & 2\end{matrix}\end{matrix} ) ( \begin{matrix}\begin{matrix}0 & 0 & 0 & 1 & 1\end{matrix} \\ \begin{matrix}1 & 0 & 0 & 0 & 1\end{matrix} \\ \begin{matrix}1 & 1 & 0 & 0 & 0\end{matrix} \\ \begin{matrix}0 & 0 & 1 & 0 & 1\end{matrix} \\ \begin{matrix}0 & 0 & 1 & 1 & 0\end{matrix} \\ \begin{matrix}1 & 0 & 0 & 1 & 0\end{matrix} \\ \begin{matrix}0 & 1 & 0 & 0 & 1\end{matrix} \\ \begin{matrix}1 & 0 & 1 & 0 & 0\end{matrix} \\ \begin{matrix}0 & 1 & 1 & 0 & 0\end{matrix} \\ \begin{matrix}0 & 1 & 0 & 1 & 0\end{matrix}\end{matrix} )$$

The binary vectors can then be encoded using the arithmetic encoder 212. The magnitude vectors can be recovered, after arithmetic decoding, by counting the number of zeros preceding each one.

The signs of the pulses can be represented by a binary vector in which the bit value represents the sign, e.g., a bit value of 1 can represent a negative sign, and a bit value of 0 a positive sign. If the CELP encoder 210 outputs sign information differently, the pulse information encoder 211 can reformat the sign information in the foregoing manner.

The pulse information encoder 211 is coupled to the arithmetic encoder 212. The arithmetic encoder 212 encodes the pulse information received from the CELP encoder 210 through the pulse information encoder 211. The operation of the arithmetic encoder 212 is described more fully below. By using an arithmetic encoder, storing a large codebook is avoided.

The arithmetic encoder 212 is coupled to a channel encoder 217 which is coupled to a transmitter 214 of a transceiver 216. The transceiver 216 also includes a receiver 218. The receiver 218 is coupled to an arithmetic decoder 220 through a channel decoder 219. The arithmetic decoder 220 outputs pulse information. The operation of the arithmetic decoder 220 is described more fully below. The arithmetic decoder 220 is coupled through a pulse information decoder 221 to a CELP decoder 222. The pulse information decoder 221 performs the inverse of the processes performed by the pulse information encoder 211. The CELP decoder 222 reconstructs a digital representation of speech audio (digitized audio signal) using the pulse information. The CELP decoder 222 is coupled to a digital-to-analog converter (D/A) 224 that is coupled through a second amplifier 226 to a speaker 228.

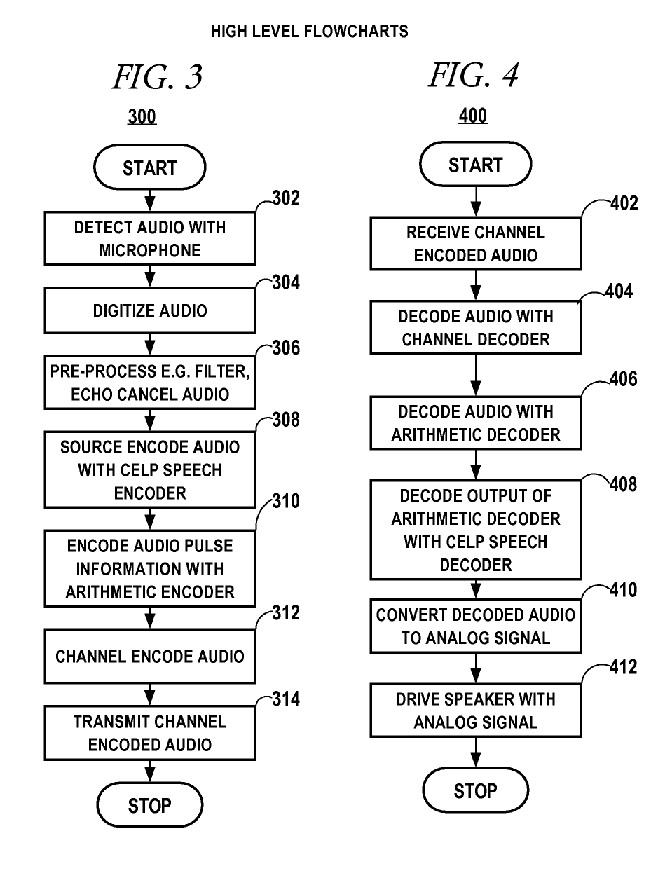

FIG. 3 is a high level flowchart of a method 300 of processing audio to be transmitted according to an embodiment of the invention. In block 302 audio is detected with a microphone. In block 304 the audio is digitized. In block 306 the audio is pre-processed which can for example comprise filtering and echo canceling. In block 308 the audio is encoded with a CELP speech encoder. In block 310 the audio pulse information output of the CELP speech encoder is encoded with an arithmetic encoder. In block 312 the audio is channel encoded and in block 314 the channel encoded audio is transmitted.

FIG. 4 is a high level flowchart of a method 400 of processing received digital audio signals according to an embodiment of the invention. In block 402 channel encoded audio is received. In block 404 the audio is decoded with a channel decoder. In block 406 the audio is decoded with an arithmetic decoder. In block 408 the output of the arithmetic decoder is decoded with a CELP speech decoder. In block 410 the output of the CELP speech decoder is converted to an analog signal, and in block 412 the analog signal is used to drive a speaker.

According to alternative embodiments of the invention, parts of the methods shown in FIGS. 3-4 are used in a transcoder in which case detecting audio with a microphone or outputting audio through a speaker will not be done. Such a transcoder can be used at a gateway between two disparate networks for example.

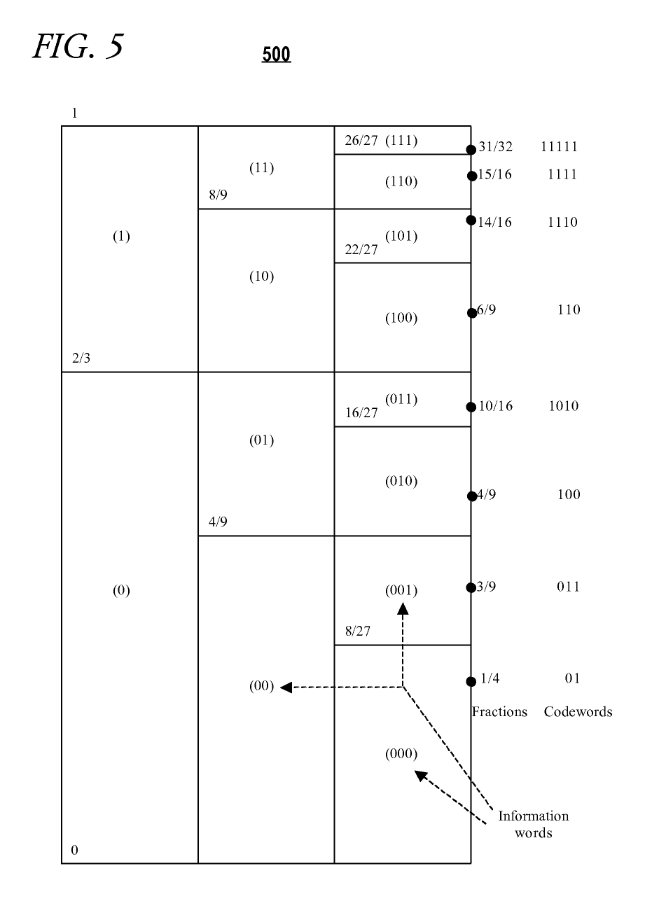

FIG. 5 is a diagram 500 illustrating the principle of arithmetic encoding for a binary sequence. The diagram 500 is divided into three columns. Each column corresponds to a bit position in a bit sequence to be encoded, with the column at the left corresponding to the first bit position. The diagram can be used for any 3-bit sequence. There are 8 possible 3-bit sequences. The diagram 500 is based on the assumption that there is a fixed probability of 2/3 that any bit in the sequence is a 0 and consequently a fixed probability of 1/3 that any bit is a 1. This is just an example for purposes of illustration. The code space is the domain from zero to one, [0,1). Each possible 3-bit sequence is to be encoded as a binary fraction in the range from zero to one. The diagram 500 works as follows. The left hand column is divided into an area for sequences that start with zero and an area for sequences that start with one. The relative size of the areas depends on the probability of emitting the respective values (e.g., 2/3 for 0 and 1/3 for 1). In each successive column the areas from the preceding column are again apportioned to binary one and binary zero according to their respective probabilities. Thus, the code space is most finely divided in the last (right side) column. Any given 3-bit sequence corresponds to a particular area of the last column. A fraction that falls within the area corresponding to a 3-bit sequence is used as a code for that 3-bit sequence. The fraction is represented in binary. Generally speaking, the smaller the area assigned to a particular 3-bit sequence, the longer is the code required to represent that sequence by a binary fraction.

Although in the foregoing the probability of ones and zeros is assumed to remain fixed, alternatively the probabilities can vary. In certain embodiments total number of ones (or zeros) is known a priori or separately transmitted beforehand, and at any bit position in a sequence being encoded the probability of a zero is computed as the ratio of the number of zeros yet to be encountered to the total number of bits yet to be processed.

In the example shown in FIG. 5 different 3-bit sequences map to regions of the code space of different sizes. However if one considers all the different n-bit sequences having a predetermined number, say k<n ones, and if the probability of a zero is computed as the aforementioned ratio, then it is the case that all of the different n-bit sequences having k ones will map to regions of equal size. In other words the code space will be portioned into equal size regions. The number of regions N_{P}(n,k) representing the number of possible sets of pulse positions is given by:

$${N}_{P} ( n , k ) = ( \begin{matrix}n \\ k\end{matrix} ) = \frac{n !}{k ! ( n - k ) !} = \frac{n \cdot ( n - 1 ) \cdot … \cdot ( n - k + 1 )}{k \cdot ( k - 1 ) \cdot … \cdot 1}$$

However, in practice, the width of the code space interval corresponding to a source sequence may not exactly be equal to 1/N_{P}(n,k) because of the rounding operations necessary to perform fixed-precision arithmetic. The actual width of the interval corresponding to a source sequence depends on the sequence itself and the precision used in the calculations. While this is cumbersome to compute, a bound can be derived for the minimum length of the code words I_{P}(n,k,w) based on a few conservative assumptions. For example, it can be shown that (see Appendix I):

I_{P}(n, k, w)=┌log₂ N_{P}(n, k)+Ω(n, k, w)┐, where

Ω(n, k, w)=log₂(1/1−(n/k)2^{-(w+1)})+log₂(1/1−(n−1/k−1)2^{-(w+1)})+ . . . +log₂(1/1−(n−k+1/1)2^{-(w+1)})+log₂(1/1−(n/n−k)2^{-(w+1)})+log₂(1/1−(n−1/n−k−1)2^{-(w+1)})+ . . . +log₂(1/1−(k+1/1)2^{-(w+1)})

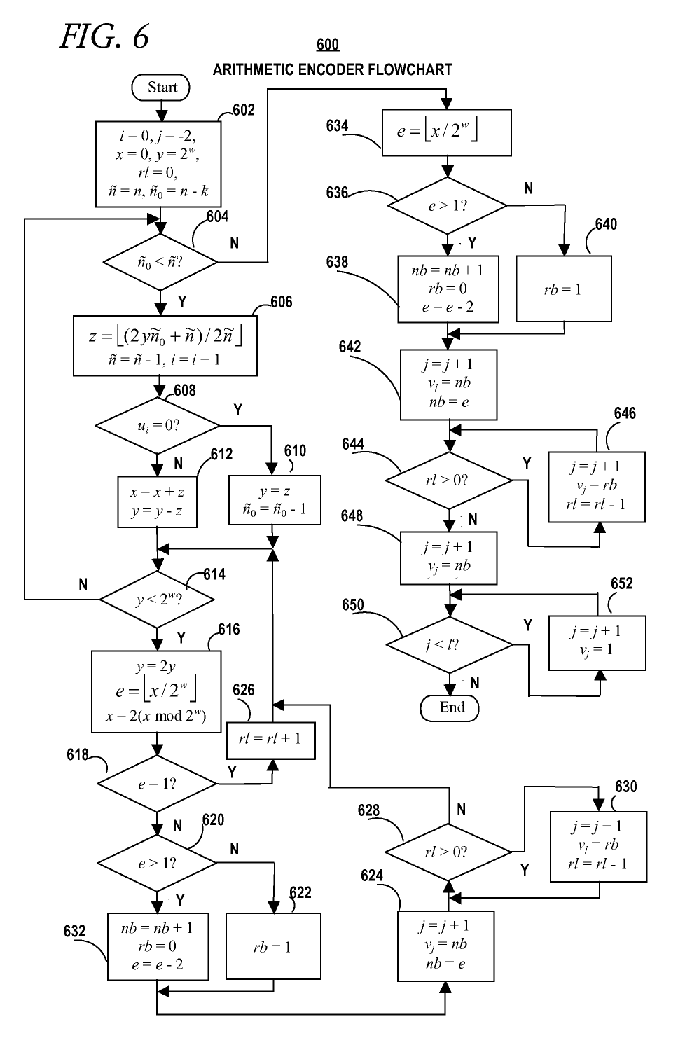

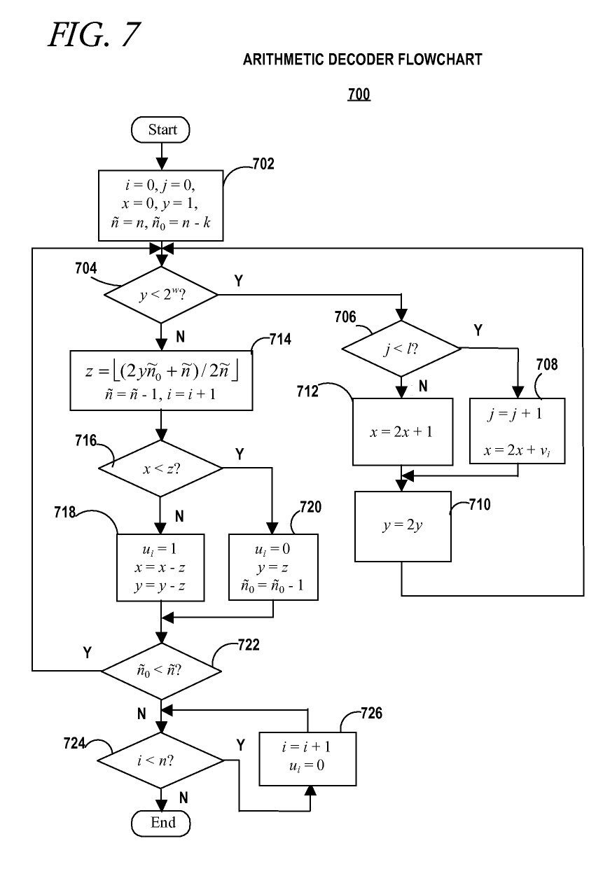

In the equations above, w represents a precision parameter, i.e., (starting) positions, and (the widths of the) intervals in the code space are stored using w+2 and w+1 bits respectively. In general, in order to compute such positions (denoted x) and intervals (denoted y) in the code space, binary registers that are up to 2*(w+2) bits wide will need to be used assuming that the input symbol probabilities (e.g., probabilities of binary digits 0 and 1) are also represented using (w+1) bits. Binary registers of such width are used to store a numerator of a parameter z that is discussed below in the context of FIGS. 6-7 and is used in calculating intervals and positions in the code space. According to embodiments of the present invention, arithmetic encoders and decoders produce and decode code words I_{P}(n,k,w) bits long using at least 2*(w+2) bits, and for efficiency sake, preferably less than 2*(w+2)+8 bits, more preferably less than 2*(w+2)+3 bits, and even more preferably exactly 2*(w+2) bits. It will not always be possible to use exactly 2*(w+2) bits because concessions may have to be made to other demands, e.g., other processes using a shared processor.

FIG. 6 is a flowchart 600 of an arithmetic encoder according to an embodiment of the invention, and FIG. 7 is a flowchart 700 of an arithmetic decoder according to an embodiment of the invention. The flowcharts in FIG. 6 and FIG. 7 can be used respectively to encode and decode the positions and magnitudes of the pulses. The number of pulses and the signs of the pulses can also be encoded and decoded using appropriately configured arithmetic encoders and arithmetic decoders respectively. A single code word can be computed to represent collectively the number of pulses, the positions, the magnitudes, and the signs of the pulses. Alternately, individual code words can be computed to represent separately the number of pulses, the positions, the magnitudes, and the signs of the pulses, and optionally these individual code words can be concatenated to form a single code word. Between the two extremes above any other combination is also possible, for example, a single code word can be computed to represent the positions and magnitudes together, and two individual code words can be computed to represent the number of pulses and the signs separately. The variables used in FIG. 6 and FIG. 7 are defined in Table I below:

TABLE I

| | | Upper |
|---|---|---|
| Symbol | Meaning | bound |
| uᵢ | i^{th} information bit | 1 |
| i | index for the information word α: u₁, u₂, . . . , uₙ | n |
| vⱼ | j^{th} code bit | 1 |
| j | index for the codeword β: v₁, v₂, . . . , Vₗ | l |
| w | precision parameter | design |
| | | value |
| x | (w + 2) least significant bits of the start of the | 2^{w+2} − 1 |
| | interval corresponding to α and its prefixes | |
| y | (w + 1) least significant bits of the width of the | 2^{w+1} − 1 |
| | interval corresponding to α and its prefixes | |
| n | number of information bits | design |
| | | value |
| l | number of code bits | design |
| | | value |
| k | number of 1's in α, i.e., the weight of α | design |
| | | value |
| ñ | number of bits yet to be scanned in α | n |
| ñ₀ | number of 0's yet to be scanned in α | n − k |
| z | value of └(2yñ₀ + ñ)/2ñ┘ | y |
| e | ejected value from x, a code bit plus a possible carry | 3 |
| nb | next bit to be stored away (or transmitted) | 1 |
| rb | run bit, 0 if there is a carry and 1 if there is none | 1 |
| rl | run length | l |

A mathematical foundation of arithmetic encoding is given in the first part of Appendix I. Referring to FIG. 6 the encoding algorithm will be described. In block 602 the variables i, j, x, y, rl, ñ, and ñ₀ are initialized. Recall that in FIG. 5 the code space was the interval [0,1). The value 2^{w} to which y is initialized in some sense represents the upper bound 1 of the code space. 2^{w} can be viewed as a scale factor, and using such an integer scale factor allows the arithmetic coding to be performed using fixed precision integer arithmetic, which means that less computing power is needed to perform the encoding.

After block 602, decision block 604 tests if there are any remaining ones in the sequence α being encoded. If so the flowchart branches to block 606 in which the quantity z is computed, the number of information bits yet to be coded ñ is decremented, and the index i is incremented. Initially the outcome of decision block 604 is positive. The quantity z is related to the size of the portion of the code space that is associated with a zero value for a current bit position in the sequence being encoded and is a fraction of the portion of the code space associated with a previous bit. This can be understood by referring to second column of FIG. 5 in which it is seen that the regions of the first column associated with zero and one are further subdivided in column two into regions proportional to the probability of each bit value. FIG. 5 is constructed using a fixed probability of 2/3 for a zero bit and 1/3 for 1 bit throughout the sequence. The arithmetic encoder as shown in FIG. 6 works differently. In particular the probability of a zero bit is set to the number of zero bits remaining divided by the total number of bits remaining. This is accomplished in the computation of z in block 606. Given the region corresponding to a previous bit represented by the integer y, the region corresponding to a zero bit at the current position is obtained by multiplying y with the probability of a zero bit and rounding the result to the nearest integer. As shown, a bias of ½ and the floor function are used for rounding to the nearest integer. Alternatively, fixed probabilities can be used. For example if the pulse sign information is to be encoded separately, and there is an equal probability of pulses being positive and negative, the computation of z can be based on fixed probabilities of zero and one bits equal to ½.

Next the flowchart 600 reaches decision block 608 which tests if the current bit in the sequence being encoded, identified by index i, is a zero or one. If the current bit is a zero then in block 610 the value y is set equal to z and ñ₀ (the number of zeros yet to be encountered) is decremented. The value of x is unchanged. On the other hand if the current bit is a one then in block 612 y is set equal to a previous value of y minus z and x is set equal to a previous value of x plus z. The new value of y is a proportion of the previous value of y with the proportion given by the probability of the current bit value (zero or one). x and y are related respectively to the starting point and the width of the area within the code space [0,1) as represented by [0,2^{w}) that corresponds to the bit sequence encoded so far.

After either block 610 or 612 decision block 614 is reached. Decision block 614 tests if the value of y is less than 2^{w}. (Note that blocks 606, 610 and 612 will reduce the value of y.) If so then in block 616 the value of y is scaled up by a factor of 2 (e.g., by a left bit shift), the value of e is computed, and the value of x is reset to 2(x mod ₂^{w}). Using the mod function essentially isolates a portion of x that is relevant to remaining, less significant code bits. Because both y and x are scaled up in block 616 in a process referred to as renormalization, even as the encoding continues and more and more information bits are being encoded, the full value of 2^{w} is still used as the basis of comparison of x in the floor function to determine the value of the code bits. Similarly, the full value of 2^{w} is still used as the basis of comparison of y in the decision block 614.

After block 616, decision block 618 tests if the variable e is equal to 1. If the outcome of decision block 618 is negative, then the flowchart 600 branches to decision block 620 which tests if the variable e is greater than 1 (e.g., if there is an overflow condition). If not, meaning that the value of e is zero, the flowchart 600 branches to block 622 wherein the value of the run bit variable rb is set equal to 1.

Next the flowchart 600 reaches block 624 in which the code bit index j is incremented, the code bit vⱼ is set equal to value of nb, and then nb is set equal to e. Note that for the first two executions of block 624, j is set to values less than one, so the values of vⱼ that are set will not be utilized as part of the output code.

When the outcome of decision block 618 positive the flowchart 600 will branch through block 626 in which the run length variable rl is incremented and then return to decision block 614. Decision block 628 tests if the run length variable rl is greater than zero—the initial value. If so then in block 630 the index j is incremented, code bit vⱼ is set to the run bit variable rb, and the run length rl is decremented, before returning to decision block 628. When it is determined in decision block 628 that the run length variable rl is zero the flowchart 600 returns to block 614.

If the outcome of decision block 620 is positive, i.e., an overflow condition has been detected, then the flowchart 600 branches to block 632 in which the nb variable is incremented, the rb variable is zeroed, and the e is decremented by 2, after which the flowchart 600 proceeds with block 624.

If it is determined in decision block 604 that only zeros remain in the sequence being encoded, then the flowchart 600 branches to block 634 in which the value of the variable e is computed as the floor function of x divided by 2^{w}. Next decision block 636 tests if e is greater than 1. If so then in block 638 the next bit variable nb is incremented, the run bit variable rb is set equal to 0, and the variable e is decremented by 2. If the outcome of decision block 636 is negative, then in block 640 the run bit variable rb is set equal to 1. After either block 638 or 640, in block 642, the index j is incremented, the code bit vⱼ is set equal to the next bit variable nb, and the next bit variable nb is set equal to e.

Next decision block 644 tests if the run length variable rl is greater than zero. If so then in block 646 the index j is incremented, the code bit vⱼ is set equal to the run bit variable rb, and the run length variable rl is decremented, after which the flowchart 600 returns to block 644.

After block 644 in block 648 the index j is incremented, and the code bit vⱼ is set equal to the next bit variable nb. Next decision block 650 tests if the index j is less than the code length l. If so then block 652 sets remaining code bits to 1. When j reaches l the encoding terminates.

Referring to FIG. 7 a flowchart 700 of an arithmetic decoding method corresponding to the encoding method shown in FIG. 6 will be described. In block 702 the variables i, j, x, y, ñ, and ñ₀ are initialized. Decision block 704 tests if y is less than 2^{w}. When, as is the case initially, this is true, the flowchart 700 branches to decision block 706 which tests if the index j is less than l. When, as is the case initially, this is true, the flowchart 700 braches to block 708 in which j is incremented, and the variable x is reset to 2x+vᵢ. Basically, successive executions of block 708 build up the value of x based on the values of the code bits, taking into account the position (significance) of the bits. After block 708 in block 710 the value of y is similarly increased by multiplying by two. After block 710 the flowchart 700 returns to decision block 704. When the end of the codeword is reached, i.e., after j reaches l, the outcome of decision block 706 will be negative, and in this case, in block 712 x is set to 2x+1. This is equivalent to reading in a code bit with a value of 1.

After block 712 block 710 is executed. When it is determined in decision block 704 that y is not less than 2^{w}, the flowchart 700 branches to block 714 which computes the value of z as shown, decrements the number of information bits yet to be decoded n, and increments the index i which points to bits of the decoded sequence. Next decision block 716 tests if x is less than z. If not then in block 718 an i^{th} decoded bit uᵢ is set equal to one, x and y are decremented by z to account for the parts of x and y represented by the i^{th} bit just decoded. If decision block 716 determines that x is less than z then in block 720 the i^{th} decoded bit uᵢ is set equal to zero, y is set equal to z, and the number of zeros yet to be encountered no is decremented to account for the zero bit uᵢ just decoded.

After either block 718 or 720 decision block 722 tests if the number of zeros remaining is less than the total number of bits remaining. If the outcome of block 722 is affirmative, the flowchart 700 loops back to decision block 704. If the outcome of block 722 is negative, the flowchart branches to decision block 724 which tests if i is less than n. If so block 726 zero fills the remaining bits. When the outcome of decision block 724 is negative the decoding process terminates.

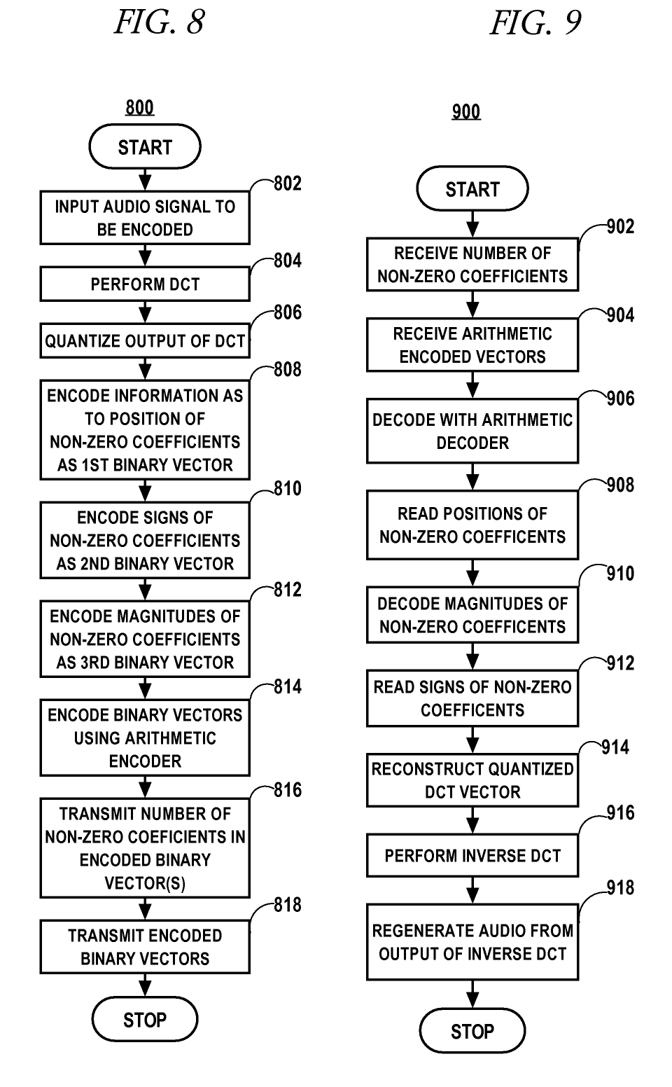

FIG. 8 is a high level flowchart of a method 800 of processing audio to be transmitted according to an alternative embodiment of the invention. In block 802 audio to be encoded is input. The audio can, for example, be input through a D/A from a microphone. Optionally the audio can be passed through a noise filter or echo canceller. In block 804 a DCT is applied to the audio. One type of DCT that may be used is the Modified DCT (MDCT). The MDCT is distinguished by reduction of encoding artifacts. For many audio signals, DCTs such as the MDCT only produce a few coefficients of significant magnitude. In block 806 the output of the DCT is quantized, e.g., using an uniform scalar quantizer. Quantization will result in many low magnitude coefficients being set to zero, such that, for many audio signals, there will only be a relatively small number of non-zero DCT coefficients. Because of this, the quantized output of the DCT (e.g., MDCT) can be efficiently encoded, as will be described below, using arithmetic encoding.

In block 808 information as to the position of any non-zero coefficients is encoded in a first binary vector. The length of the first binary vector is equal to the number of DCT coefficients, and each bit in the first binary vector is set to a one or a zero depending on whether the corresponding (by position) coefficient of the quantized DCT output is non-zero or zero.

In block 810 the signs of the non-zero quantized DCT coefficients are encoded in a second binary vector. The second binary vector need only be as long as the number of non-zero quantized DCT coefficients. Each bit in the second binary vector is set equal to a zero or a one depending on whether the corresponding non-zero quantized DCT coefficient is negative or positive. As discussed above arithmetic coding and decoding of binary vectors encoding sign information can be based on assumed fixed probabilities of ½ for both zero and one, and therefore it is not necessary to transmit the number of ones (or zeros) in such vectors.

In block 812 the magnitudes of the non-zero quantized DCT coefficients are encoded in a third binary vector. The method of encoding magnitudes described above with reference to the pulse information encoder 211 is suitably used. Note that according to certain embodiments the sum of the magnitudes of the coefficients is a fixed (design) value, and in such cases the number of zeros in binary vectors encoding the magnitudes will also be fixed and therefore need not be transmitted.

In block 814 one or more of the first through third binary vectors are encoded using an arithmetic encoder. Two or more of the first through third binary vectors can be concatenated and encoded together by the arithmetic encoder, or the binary vectors can be encoded separately by the arithmetic encoder. In block 816 the number of non-zero DCT coefficients are transmitted. The number of non-zero DCT coefficients can be encoded (e.g., arithmetic encoded or Huffman encoded) prior to transmission. In block 818 the encoded binary vectors are transmitted.

FIG. 9 is a high level flowchart of a method 900 of processing received digital audio signals according to an alternative embodiment of the invention. The method 900 decodes the encoded vectors generated by the method 800. In block 902 the number of non-zero DCT coefficients that was transmitted in block 816 is received (and decoded). In block 904 the arithmetic encoded vector(s) transmitted in block 818 are received. In block 906 the encoded vectors are decoded with an arithmetic decoder. In block 908 the positions of the non-zero coefficients are read from the first binary vector. In block 910 the magnitudes of the non-zero coefficients of the quantized DCT are decoded from the third binary vector. In block 912 signs of the non-zero coefficients of the quantized DCT are read from the second binary vector. In block 914 the quantized DCT vector is reconstructed based on the information obtained from the first through third binary vectors, and in block 916 the inverse DCT transform is performed on the reconstructed quantized DCT vector. In block 918 a sub-frame of audio is regenerated from the output of the inverse DCT. The flow charts in FIGS. 8-9 can also be used to process residual audio signals, that is, the difference between an original audio signal and a coded version of the original, as encountered often in embedded audio coders.

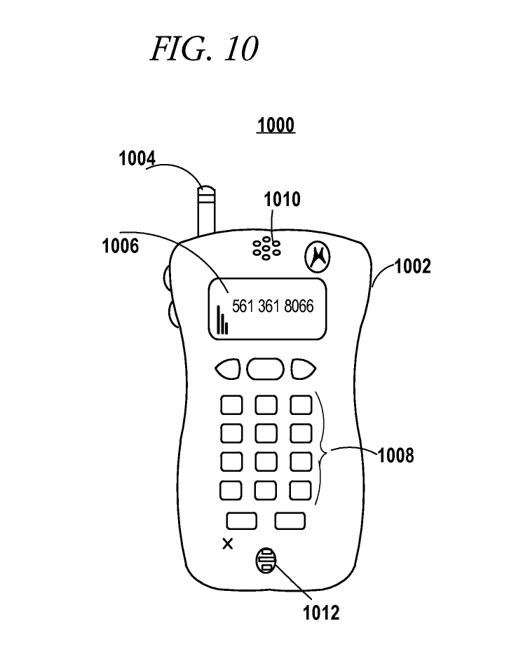

FIG. 10 is a front view of a wireless communication device, in particular a cellular telephone handset 1000 according to an embodiment of the invention. The handset 1000 includes a housing 1002 supporting an antenna 1004, display 1006, keypad 1008, speaker 1010 and microphone 1012. Although a “candy bar” form factor handset is shown in FIG. 10, one skilled in the art will appreciate that the encoders and decoders disclosed herein can be incorporated in a myriad of devices of different form factors.

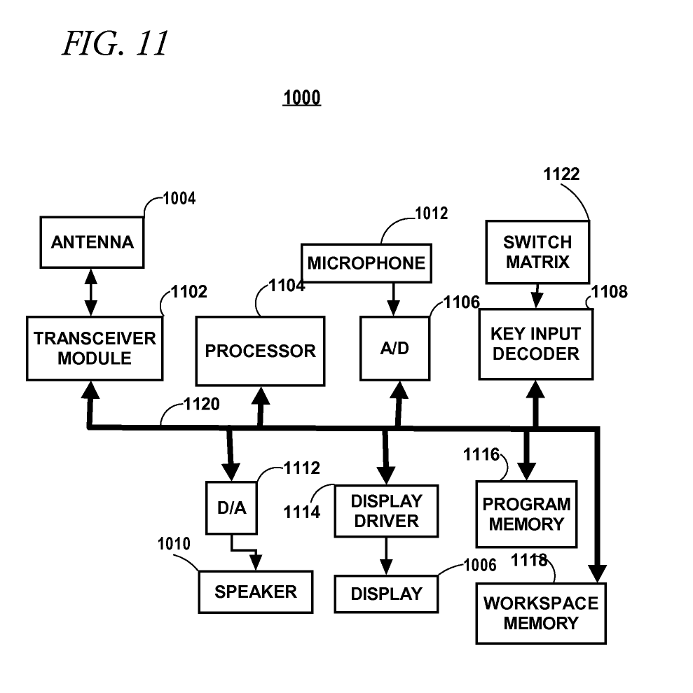

FIG. 11 is a block diagram of the wireless communication device 1000 shown in FIG. 10 according to an embodiment of the invention. As shown in FIG. 11, the wireless communication device 1000 comprises a transceiver module 1102, a processor 1104 (e.g., a digital signal processor), an analog to digital converter (A/D) 1106, a key input decoder 1108, a digital to analog converter (D/A) 1112, a display driver 1114, a program memory 1116, and a workspace memory 1118 coupled together through a digital signal bus 1120.

The transceiver module 1102 is coupled to the antenna 1004. Carrier signals that are modulated with data, e.g., audio data, pass between the antenna 1004 and the transceiver module 1102.

The microphone 1012 is coupled to the A/D 1106. Audio, including spoken words and ambient noise, is input through the microphone 1012 and converted to digital format by the A/D 1106.

A switch matrix 1122 that is part of the keypad 1008 is coupled to the key input decoder 1108. The key input decoder 1108 serves to identify depressed keys and to provide information identifying each depressed key to the processor 1104.

The D/A 1112 is coupled to the speaker 1010. The D/A 1112 converts decoded digital audio to analog signals and drives the speaker 1010. The display driver 1114 is coupled to the display 1006.

The program memory 1116 is used to store programs that control the wireless communication device 1000. The programs stored in the program memory 1116 are executed by the processor 1104. The workspace memory 1118 is used as a workspace by the processor 1104 in executing programs. Methods that are carried out by programs stored in the program memory 1116 are described above with reference to FIGS. 1-9. The program memory 1116 is a form of computer readable media. Other forms of computer readable media can alternatively be used to store programs that are executed by the processor 1104.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

### Appendix I

A) Mathematical Foundation of Arithmetic Coding:

In arithmetic coding, each information word to be coded is assigned a unique subinterval within the unit interval [0, 1). The computation of this interval can be performed recursively with the knowledge of the probabilities of the symbols within the information word. A point within the interval is then selected, and a fractional representation of this point is used as the codeword.

Mathematically, let α denote a binary information word and l(α)=[x(α), x(α)+y(α)) denote the interval corresponding to α where x(α) denotes the start of the interval and y(α) denotes the width of the interval. When α is just the empty sequence ε, we define

x(ε)=0.0 and y(ε)=1.0,

so that l(ε)=[0, 1). If the interval corresponding to α is known, then the intervals corresponding to α0 and α1 (i.e., the concatenation of α and either 0 or 1 respectively) can be computed as follows.

x(α0)=x(α),

y(α0)=y(α) P(0|α),

x(α1)=x(α)+y(α) P(0|α), and

y(α1)=y(α) P(1|α)=y(α) (1−P(0|α))=y(α)−y(α) P(0|α),

where P(0|α) and P(1|α) (=1−P(0|α)) denote respectively the probabilities of a 0 or 1 bit following the bit sequence α. Using the notation z(α)=y(α) P(0|α) in the above equations, we have

x(α0)=x(α),

y(α0)=z(α),

x(α1)=x(α)+z(α), and

y(α1)=y(α)−z(α).

Computation of the interval l(α) corresponding to α using the above recursive equations requires infinite precision. In arithmetic coding, rounding and scaling (or renormalization) operations are used which allow the computation of l(α) to be performed using finite precision arithmetic. However, the computed interval is now only an approximation of the actual interval. Let us define the integers x*(α), y*(α), L(α), and w so that x(α) and y(α) can be expressed using finite precision (i.e., using L(α)+w bits) as

x(α)=x*(α)/2^{L(α)+w}, and

y(α)=y*(α)/2^{L(α)+w}.

The recursive equations for the computation of the interval l(α) are now reformulated as follows. For the empty sequence ε, we define

x*(ε)=0, y*(ε)=2^{w}, and L(ε)=0.

If x*(α), y*(α), and L(α) are known for a sequence α, then we have

for the sequence α0:

z*(α)=└y*(α)P(0|α)+1/2┘,

x*(α0)=x*(α)2^{d0},

y*(α0)=z*(α)2^{d0}, and

L(α0)=L(α)+d0,

where d0 is an integer for which 2^{w}≦y*(α0)<2^{w+1}; and

for the sequence α1:

z*(α)=└y*(α)P(0|α)+1/2┘,

x*(α1)=(x*(α)+z*(α))2^{d1},

y*(α1)=(y*(α)−z*(α))2^{d1}, and

L(α1)=L(α)+d1,

where d1 is an integer for which 2^{w}≦y*(α1)<2^{w+1}.

In the above equations, the rounding operation used in the computation of z*(α) ensures that it is expressed in finite precision (w+1 bits). Also, the choice of d0 (respectively d1) used in scaling y*(α0) (respectively y*(α1)) ensures that the scaled interval width has enough precision (w+1 bits) for further subdivision. The precision parameter w is a design value and should be chosen to suit the coding application. A choice of w=14, for example, provides enough precision for general applications and also allows standard integer arithmetic to be used in computing the codeword.

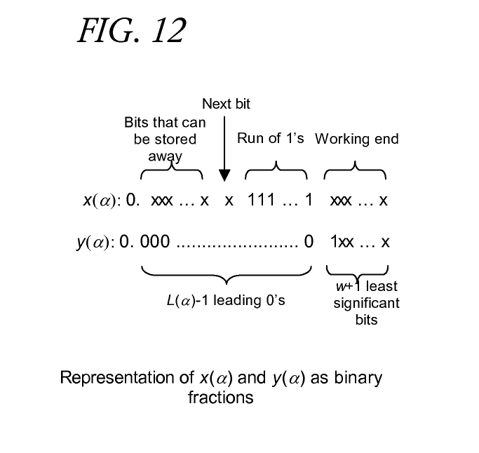

The binary fractional representations of x(α) and y(α) are shown in FIG. 12. Since y*(α) is always bounded by 2^{w}≦y*(α)<2^{w+1}, the binary fractional representation of y(α) has L(α)−1 leading zeros followed by w+1 least significant bits. The storage of y(α) therefore requires only a (w+1) bit register. Unlike y(α), x(α) is not bounded and can keep increasing in length as more and more information bits are coded. However, its binary representation can be thought of as consisting of four parts: 1) the most significant bits which will not undergo any further change and therefore can be stored away in a suitable medium or transmitted, 2) the next bit (to be stored away), 3) a run of 1's, and 4) the working end of (w+1) least significant bits. The next bit, the run length, and the working end can be stored in suitable registers. Both the next bit and the run bit may undergo a change if there is a carry (overflow condition) out of the working end.

B) Bounding the Codeword Length:

Consider the encoding of an n-bit sequence using the flowchart 600 in FIG. 6. At any position within the sequence, the probability of a 0 is defined by the ratio n̅₀/ n̅ which can be exactly represented by the integers n̅₀ and n̅. Therefore, the only source of error in computing x(α) and y(α) arises due to the rounding operation in the computation of z*(α). Using the recursive equations above and the inequality g−1<└g┘≦g for g real, we can express

y*(α0)/2^{L(α0)+w}>(y*(α)P(0|α)−1/2))/2^{L(α)+w}, and

y*(α1)/2^{L(α}1)+w≧(y*(α)P(1|α)−1/2))/2^{L(α)+w}.

Combining the two expressions, we have

y*(αu)/2^{L(αu)+w}≧(y*(α)P(u|α)−1/2))/2^{L(α)+w}

where u is a 0 or 1. The above expression can be rewritten as

$$y ( α u ) \geq y ( α ) P ( u \vert α ) ( 1 - \frac{1}{2 y * ( α ) P ( u \vert α )} ) .$$

Since y*(α)≧2^{w}, we have

$$y ( α u ) \geq y ( α ) P ( u \vert α ) ( 1 - \frac{δ}{P ( u \vert α )} )$$

where δ=2^{-(w+1)}. Applying the above relationship recursively to the input bit sequence (i.e., information word) α=u₁, u₂, . . . , uₙ and recalling that y(ε)=1, we have

$$y ( α ) \geq P ( {u}_{1} \vert ɛ ) P ( {u}_{2} \vert {u}_{1} ) … P ( {u}_{n} \vert {u}_{1} {u}_{2} … {u}_{n - 1} )$$

$$( 1 - \frac{δ}{P ( {u}_{1} \vert ɛ )} ) ( 1 - \frac{δ}{P ( {u}_{2} \vert {u}_{1} )} ) … ( 1 - \frac{δ}{P ( {u}_{n} \vert {u}_{1} {u}_{2} … {u}_{n - 1} )} )$$

The expression P(u₁|ε)P(u₂|u₁) . . . P(uₙ|u₁u₂ . . . uₙ₋₁) represents the probability P(α) of the sequence α and is also the ideal interval width. If α is a n-bit sequence with k ones and if the probability of a zero at any position is given by ñ₀/ñ, then it can be shown that P(α)=1/N_{P}(n,k) where

$${N}_{P} ( n , k ) = ( \begin{matrix}n \\ k\end{matrix} ) .$$

Simplifying the notation by replacing P(uᵢ|u₁u₂ . . . uᵢ₋₁) by Pᵢ, we have

$$y ( α ) \geq P ( α ) ( 1 - \frac{δ}{{P}_{1}} ) ( 1 - \frac{δ}{{P}_{2}} ) … ( 1 - \frac{δ}{{P}_{n}} ) .$$

Each term of the form

$$( 1 - \frac{δ}{{P}_{i}} )$$

reduces the interval width from the ideal value P(α) with the greatest reduction occurring for the smallest value of Pᵢ. While the actual set of probabilities {Pᵢ, i=1, 2, . . . , n} depends on the particular n-bit sequence, the following set of n probabilities {k/n, k−1/n−1, . . . , 1/n−k+1, n−k/n, n−k−1/n−1, . . . , 1/k+1} provides a lower bound for any sequence α. The codeword length l_{P}(n,k,w) should be chosen such that 2^{-l}^{_{P}}^{(n, k, w)}≦y(α) for unique decodability. Substituting for P(α), {Pᵢ, i=1, 2, . . . , n}, taking logarithm to the base 2, and rearranging the terms, the minimum codeword length is given by

l_{P}(n, k, w)=┌log₂ N_{P}(n,k)+Ω(n,k,w)┐, where

Ω(n,k,w)=log₂(1/1−(n/k)2^{-(w+1)})+log₂(1/1−(n−1/k−1)2^{-(w+1)})+ . . . +log₂(1/1−(n−k+1/1)2^{-(w+1)})+log₂(1/1−(n/n−k)2^{-(w+1)})+log₂(1/1−(n−1/n−k−1)2^{-(w-1)})+ . . . +log₂(1/1−(k+1/1)2^{-(w+1)})

We claim:

1. A communication device comprising:
a microphone;
an audio encoder coupled to the microphone;
an arithmetic encoder coupled to the audio encoder; and
a transmitter coupled to the arithmetic encoder.

2. The communication device according to claim 1 wherein:
the audio encoder comprises a CELP encoder.

3. The communication device according to claim 2 wherein:
the CELP encoder comprises an ACELP encoder.

4. The communication device according to claim 1 wherein:
the audio encoder comprises a Discrete Cosine Transform.

5. The communication device according to claim 1 wherein:
the arithmetic encoder performs fixed precision arithmetic using at least 2*(w+2) binary digits and produces codes having
l_{P}(n, k, w)=┌log₂ N_{P}(n,k)+Ω(n,k,w)┐ binary digits,
where
Ω(n,k,w)=log₂(1/1−(n/k)2^{-(w+1)})+log₂(1/1−(n−1/k−1)2^{-(w+1)})+ . . . +log₂(1/1−(n−k+1/1)2^{-(w+1)})+log₂(1/1−(n/n−k)2^{-(w+1)})+log₂(1/1−(n−1/n−k−1)2^{-(w+1)})+ . . . +log₂(1/1−(k+1/1)2^{-(w+1)})
and
$${N}_{P} ( n , k ) = ( \begin{matrix}n \\ k\end{matrix} )$$
n is a number of bits in a sequence to be encoded; and
k is a number of ones in said sequence to be encoded.

6. The communication device according to claim 5 wherein:
the arithmetic encoder performs fixed precision arithmetic using less than 2*(w+2)+3 bits.

7. A communication device comprising:
a receiver;
an arithmetic decoder coupled to said receiver;
an audio decoder coupled to the arithmetic decoder; and
a speaker coupled to the audio decoder.

8. The communication device according to claim 7 wherein:
the audio decoder comprises a CELP decoder.

9. The communication device according to claim 8 wherein:
the CELP decoder comprises an ACELP decoder.

10. The communication device according to claim 8 wherein:
the audio decoder comprises an inverse Discrete Cosine Transform.

11. The communication device according to claim 7 wherein:
the arithmetic decoder performs fixed precision arithmetic using at least 2*(w+2) binary digits and decodes codes having
l_{P}(n,k,w)=┌log₂ N_{P}(n,k)+Ω(n,k,w)┐ binary digits,
where
Ω(n,k,w)=log₂(1/1−(n/k)2^{-(w+1)})+log₂(1/1−(n−1/k−1)2^{-(w+1)})+ . . . +log₂(1/1−(n−k+1/1)2^{-(w+1)})+log₂(1/1−(n/n−k)2^{-(w+1)})+log₂(1/1−(n−1/n−k−1)2^{-(w+1)})+ . . . +log₂(1/1−(k+1/1)2^{-(w+1)})
and
$${N}_{P} ( n , k ) = ( \begin{matrix}n \\ k\end{matrix} )$$
n is a number of bits in a sequence decoded; and
k is a number of ones in said sequence decoded.

12. The communication device according to claim 11 wherein:
the arithmetic decoder performs fixed precision arithmetic using less than 2*(w+2)+3 bits.

13. A method of processing audio comprising:
processing audio with a CELP encoder to obtain pulse information; and
processing said pulse information with an arithmetic encoder to obtain codes representing said pulse information.

14. A method of processing audio comprising:
receiving encoded audio information;
processing said encoded audio information with an arithmetic decoder to obtain pulse information; and
processing said pulse information with a CELP decoder to obtain a digitized audio signal.

15. An arithmetic encoder that performs fixed precision arithmetic using at least 2*(w+2) binary digits and produces codes having
l_{P}(n,k,w)=┌log₂ N_{P}(n,k)+Ω(n,k,w)┐ binary digits,
where
$${N}_{P} ( n , k ) = ( \begin{matrix}n \\ k\end{matrix} )$$
n is a number of bits in a sequence to be encoded; and
k is a number of ones in said sequence to be encoded.

16. The arithmetic encoder according to claim 15 wherein fixed precision arithmetic is performed using less than 2*(w+2)+8 bits.

17. The arithmetic encoder according to claim 15 wherein fixed precision arithmetic is performed using less than 2*(w+2)+3 bits.

18. The arithmetic encoder according to claim 15 wherein fixed precision arithmetic is performed using exactly 2*(w+2) bits.
